(19) United States
(12) Patent Application Publication
(10) Pub. No.: US 2018/0338505 A1
(43) Pub. Date: Nov. 29, 2018

(54) STAMP FOR EMBOSSING OR CUTTING OUT

(71) Applicant: GLOBAL INNOVATIONS GERMANY GMBH & CO. KG, Longuich (DE)

(72) Inventor: Torsten MUENICH, Longuich (DE)

(73) Assignee: GLOBAL INNOVATIONS GERMANY GMBH & CO. KG, Longuich (DE)

(21) Appl. No.: 16/054,344

(22) Filed: Aug. 3, 2018

Related U.S. Application Data
(63) Continuation of application No. PCT/DE2016/100600, filed on Dec. 19, 2016.

(30) Foreign Application Priority Data
Feb. 3, 2016 (DE) 20 2016 000 692.5
Jun. 14, 2016 (EP) 16174389.3

(51) Int. Cl. A21C 11/10; A21C 11/02

(52) U.S. Cl. CPC A21C 11/106; A21C 11/02

(57) ABSTRACT

A stamp, especially for embossing or cutting out, with a plate having a top surface and a base surface opposite to the top surface, as well as an edge surface connecting the top surface and the base surface. The plate features at least one handle and has at least one projection protruding from the base surface and/or at least one indentation protruding into the base surface. In order to provide a stamp that can be stored in a space-saving way when not in use on the one hand and that is easy to handle when used on the other hand, the proposition is that the handle is mounted to the plate with an articulated connection and can be moved from a neutral to a usage position and vice versa.

This nonprovisional application is a continuation of International Application No. PCT/DE2016/100600, which was filed on Dec. 19, 2016, and which claims priority to German Patent Application No. 20 2016 000 692.5, which was filed on Feb. 3, 2016, and to European Patent Application No. 16174389.3 which was filed on Jun. 14, 2016, and which are all herein incorporated by reference.

### BACKGROUND OF THE INVENTION

### Field of the Invention

The present invention relates to a stamp that is especially made for embossing or cutting out.

### Description of the Background Art

Stamps, especially for embossing or cutting out dough, are known in various forms. Stamps may contain a plate featuring a handle and having a top surface and a base surface opposite to the top surface as well as an edge surface connecting the top surface and the base surface. The plate has at least one projection protruding from the base surface and/or at least one indentation protruding into the base surface. In addition, the plate features at least one handle.

### SUMMARY OF THE INVENTION

It is therefore an object of the present invention to provide a stamp that can be stored in a space-saving way when not in use on the one hand and that is easy to handle when used on the other hand.

In an exemplary embodiment, the handle is attached flexibly to the plate and can be moved from a neutral position to a usage position.

The special advantage of the invention is the fact that the stamp handle can be stored in a space-saving way when not in use and that it can be easily handled when used. Such a stamp can be easily stored in the neutral position of the handle and can therefore be also used as sales article, promotional article, give-away item, mail-order product and as supplement with products, for example on or in the products or on or in the product packages.

Basically, the handle and the plate are freely selectable within the appropriate wide limitations regarding type, form, dimensioning and material. An especially advantageous embodiment of the invention however stipulates that the handle is built and arranged on the plate in such a way that the handle in its neutral position is not much higher than the height of the plate. Here, the height of the plate is the distance between the top surface and the base surface. This minimizes the space requirement of the stamp in the neutral position of the handle, especially regarding the total height of the stamp.

The handle and the plate can be made from one piece. For example, the articulated connection of the handle and the plate can be constructed as a living hinge. This way, the construction of the stamp is simplified and saves costs. Therefore, the handle is also captively mounted on the plate.

The handle can be formed like a bow handle which is attached to the plate with two spaced-apart hinges. This makes a large grip surface possible, further improving the usability. On the other hand, the articulated connection of the handle on the plate is more stable due to the spaced-apart hinges.

Basically, the arrangement of the handle is freely selectable within the appropriate wide limitations in relation to the plate. The handle in its neutral position can enclose the plate at least partially at the edge. Thus, a space-saving neutral position with respect to the total stamp height can be easily realized.

The handle can enclose the plate in such a way that the edge contour of the plate is basically continuous. This promotes an appealing stamp design in the neutral position of the handle.

The plate and/or the handle can be made from plastic. Plastics are easy to process, cost-effective and have low density.

The stamp height in the handle's neutral position can be less than or equal to 3.3 mm and/or that the projection has a height of and/or the indentation has a depth that is less than or equal to 1.8 mm. Thus, a use as product supplement, package insert or mail order item is further facilitated.

The stamp can have at least a first and a second projection; the second projection is built as a closed contour, is arranged peripherally to the first projection and/or the indentation and, in relation to the base surface, is higher than the first projection. For example, this makes it possible to use the stamp in one single work process for embossing and cutting out of dough or the like at the same time.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a shows an exemplary embodiment from below with the handle in its neutral position;

FIG. 1b shows the exemplary embodiment in a side view;

FIG. 1c shows the exemplary embodiment in another side view;

FIG. 1d shows the exemplary embodiment in a top view onto a top surface;

FIG. 1e shows the exemplary embodiment in a side view with the handle in its neutral and usage position;

FIG. 2a shows an exemplary embodiment of the invention in a view from below, with the handle in its neutral position;

FIG. 2b shows the exemplary embodiment in a side view;

FIG. 2c shows the exemplary embodiment in another side view;

FIG. 2d shows the exemplary embodiment in a top view onto a top surface;

FIG. 2e shows the exemplary embodiment in a side view with the handle in its neutral and usage position;

FIG. 3a shows an exemplary embodiment of the invention in a view from below, with the handles in their neutral position;

FIG. 3b shows the exemplary embodiment in a side view;

FIG. 3c shows the exemplary embodiment in another side view;

FIG. 3d shows the exemplary embodiment in a top view onto a top surface;

FIG. 3e shows the exemplary embodiment in a side view with the handles in their neutral and usage position;

FIG. 4 shows an exemplary embodiment of the invention in a view from below, with the handles in their neutral position; and

FIG. 5 shows an exemplary embodiment of the invention in a view from below, with the handles in their neutral position

### DETAILED DESCRIPTION

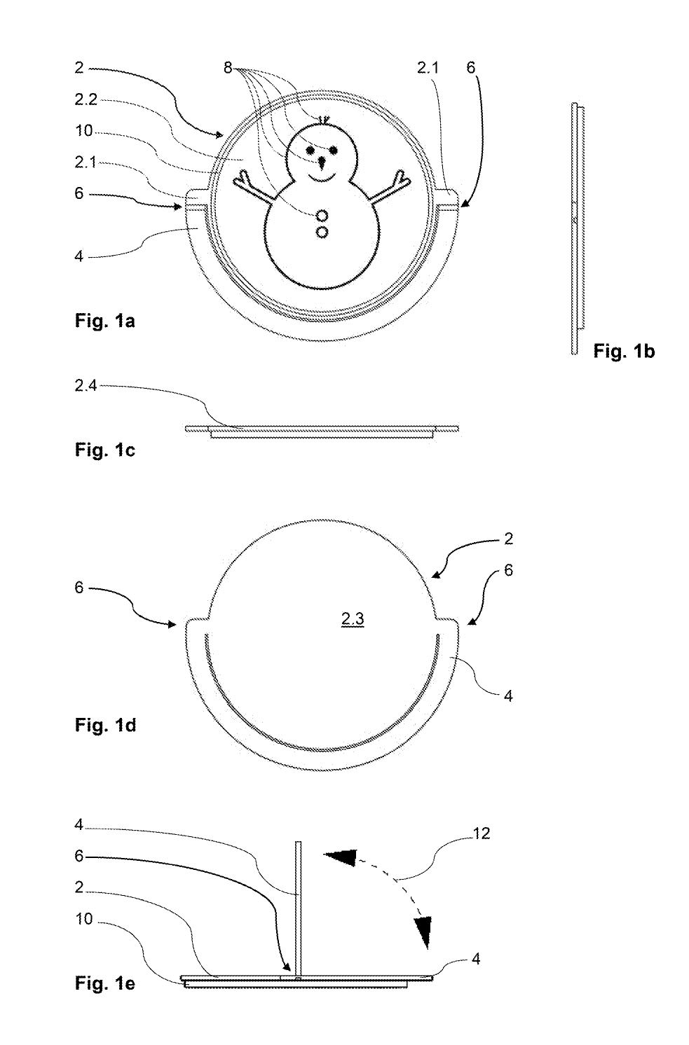

In FIGS. 1a to 1e, a first execution example of a stamp, customized according to the invention, is shown. Here, the stamp can be in the form of a cookie stamp. Cookie stamps are used to emboss motifs into the rolled-out dough. Dough pieces are cut out from the rest of the dough and baked in an oven.

The cookie stamp has a plate (2) and a bow handle (4). Here, the plate (2) and the handle (4) are formed in one piece from plastic. The bow handle (4) is connected to the plate (2) with two spaced-out hinges (6) in the form of living hinges. The living hinges (6) are formed by a material weakening between plate (2) and handle (4).

FIG. 1a to 1d are showing the stamp with the handle (4) in its neutral position while FIG. 1e is showing the handle (4) in its neutral position and usage position.

In the present execution example, the plate (2) is formed as a circular disc and the bow handle (4) essentially encloses the plate (2) in a semi-circular way. For the formation of the living hinges (6), the plate (2) has two diametrically opposed arms (2.1) on the edge in the connection surface with the bow handle (4).

The plate (2) also has a flat base surface (2.2) and a flat top surface (2.3) that relate to each other by a wraparound edge surface (2.4). Both surfaces (2.2 and 2.3) are parallel to each other, so that the height of the plate (2), i.e. the distance between the base surface (2.2) and the top surface (2.3), is continuously the same across the entire plate (2).

The plate (2) has several projections formed as first projections (8) on the base surface (2.2) shown in FIG. 1a, forming a snowman motif in total. The first projections (8) form a closed contour that forms the head, the body and the arms of the snowman, two circular contours that symbolize the buttons on the body, as well as further linear and punctiform projections that form the face and hair of the snowman. The first projections (8) rise 1.8 mm above the base surface (2.2) of the plate (2). This enables a distinct and clear embossing of the dough with a low height of the projections (8).

Furthermore, the plate (2) has a circular second projection (10). The second projection (10) is arranged at the edge of the plate (2) and rises 2 mm above the base surface (2.2). Therefore, the second projection (10) encloses the snowman motif formed by the first projections (8). For example, if the stamp according to the invention is pressed into a rolled-out dough, with the base surface (2.2) first, on a table or the like, it is possible to emboss the snowman motif in one work process and to cut out the embossed dough part with the second projection (10) from the rest of the dough.

The bow handle (4) is formed and arranged on the plate (2) in such a way that the bow handle (4) in its neutral position is not higher than the height of the plate (2). Thus, the total height of the stamp in the neutral position of the bow handle (4) corresponds to the summed-up height of the plate (2) and of the second projection (10).

In the present execution example, the total height of the stamp in the neutral position of the bow handle (4) is 3.3 mm. Because the first projections (8) are lower than the second projection (10), they do not increase the total height of the stamp.

FIGS. 1b and 1c are showing two different side views of the first execution example; FIG. 1b is showing the side view with the viewing direction from the left to the right on FIG. 1a, and FIG. 1c is showing the side view with the viewing direction from the top to the bottom on FIG. 1a; in each case relative to the plane of the paper.

FIG. 1d is showing the first execution example in a top view. FIG. 1d clearly shows that the handle (4) is only connected with the plate (2) by the two living hinges (6). The top surface (2.3) of the plate (2) is smooth, without surface structure or the like.

FIG. 1e is showing the first execution example in relation to the plane of the paper in a 90° counter-clockwise view relative to FIG. 1c. In FIG. 1e, the bow handle (4) is shown in its neutral position and its usage position.

It is clearly visible that the bow handle (4) in its neutral position—horizontal in the plane of the paper in FIG. 1e—does not increase the height of the plate (2) and as such the total height of the stamp, compared to the summed-up height of the plate (2) and the second projection (10).

In the usage position that is also shown—vertical in the plane of the paper in FIG. 1e—the bow handle (4) makes a comfortable handling of the stamp possible. For this purpose, the bow handle (4) is, originating from its neutral position, swiveled by 90° to the left in the plane of the paper by means of the living hinges (6), which is symbolized by the double arrow (12).

The bow handle (4) can, if necessary, be moved from its neutral position to the usage position or vice versa, from its usage position to the neutral position.

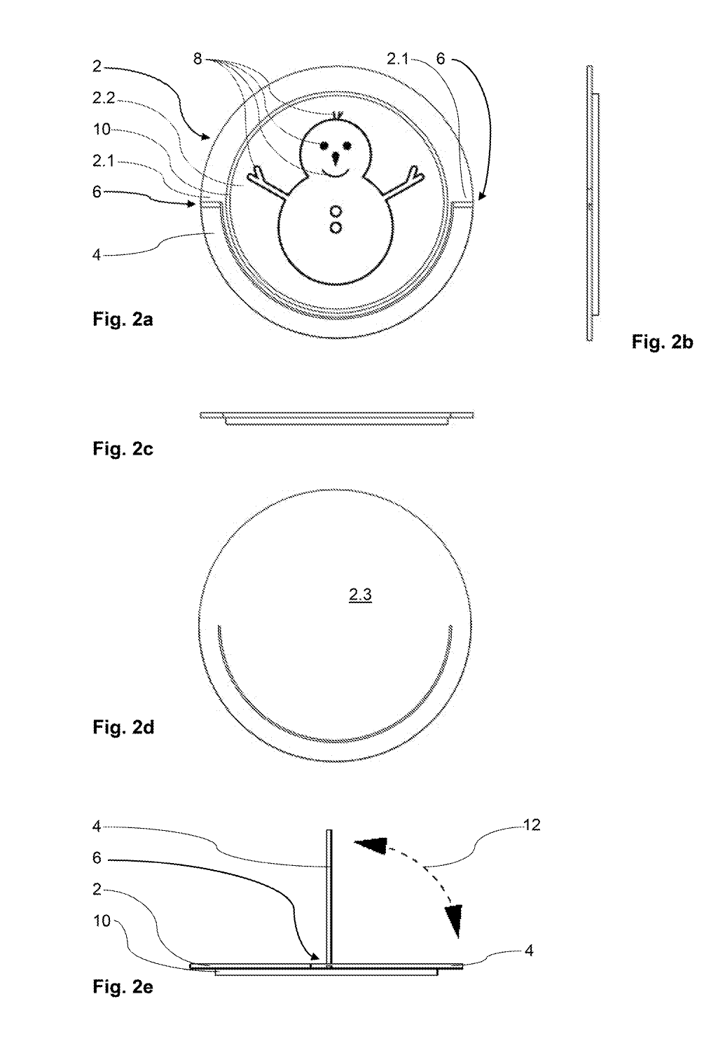

In FIGS. 2a to 2e, a second execution example is shown.

In contrast to the first execution example, the plate (2) is formed in such a way at the edge that it forms a basically closed edge contour with the bow handle (4) in its neutral position; see FIGS. 2a and 2d. Here, the arms (2.1) transition seamlessly into the remaining edge contour of the plate (2).

Thus, the bow handle (4) in its neutral position integrates into the edge contour of the plate (2) in such a way that the contour of the plate (2) has a continuous edge with the bow handle (4), i.e. without abrupt contour changes.

Apart from that, the execution form according to the second execution example is comparable with the first execution example.

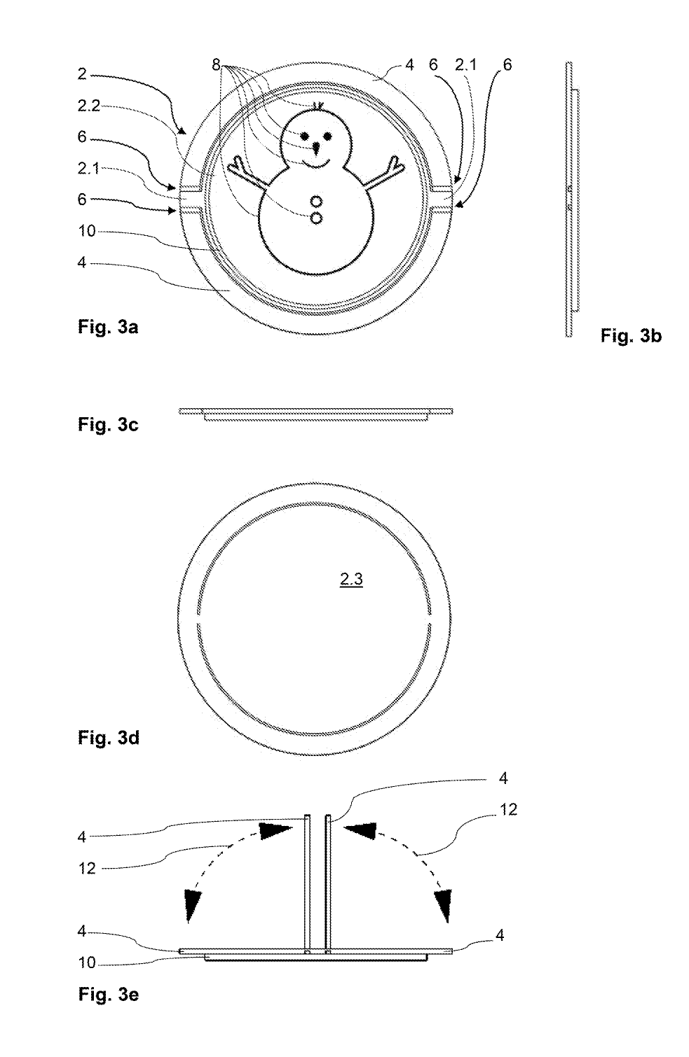

FIGS. 3a to 3e are showing a third execution example of the stamp according to the invention.

In contrast to the first two execution examples, this stamp has two diametrically opposite bow handles (4); see FIGS. 3a and 3d. The circular edge contour is basically enclosed by both bow handles (4) in their neutral position.

FIG. 3e is showing, analogous to the execution examples mentioned above, the two bow handles (4) in their neutral as well as in their usage position.

For the use of the stamp, the bow handle (4) that is positioned on the left in the plane of the paper in FIG. 3e is moved clockwise and the bow handle (4) that is positioned on the right in the plane of the paper in FIG. 3e is moved counter-clockwise from the neutral position to the usage position. The stability of the stamp is further increased by using two bow handles (4).

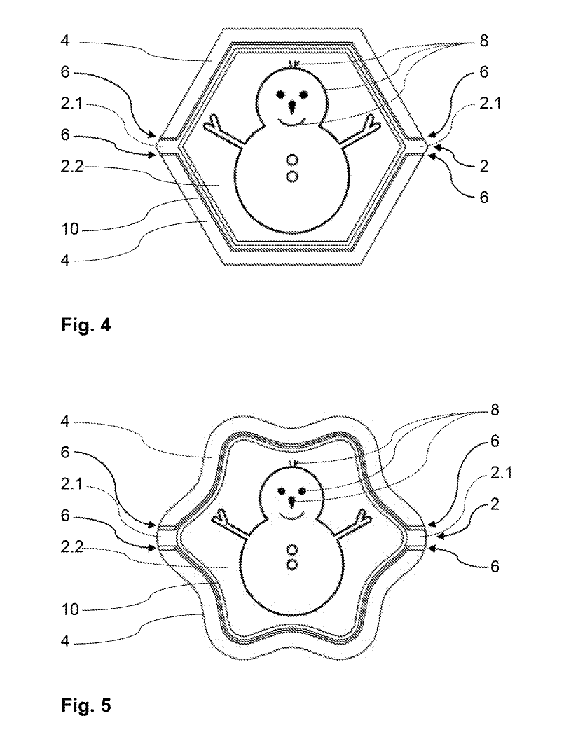

In FIG. 4, a fourth execution example is shown that is comparable to the third execution example. In contrast to the third execution example, the plate (2) has a hexagonal edge contour in the fourth execution example that is basically enclosed by two bow handles (4) in their neutral position. The two bow handles (4) follow the hexagonal edge contour of the plate (2).

The same is valid for the fifth execution example shown in FIG. 5, where the plate (2) has a hexagonal edge contour with rounded edges and circular indentations, like a flower, in contrast to the third and fourth execution example.

By analogy with that, further execution examples can be specified, where the plate (2) has a hexagonal edge contour with or without rounded edges and circular indentations, but which otherwise are either formed according to the first or the second execution example.

The invention is not limited to the present execution examples.

Other edge contours than the edge contours mentioned in the execution examples are also possible.

Furthermore, it is possible that the motif is also shown on the top surface of the plate that is facing the user during the use of the stamp. For example, the motif or other useful information for the user could be imprinted or embossed.

It is also possible that, instead of projections, at least one indentation in the base surface or a combination of at least one projection and at least one indentation is used for the formation of the motif on the base surface of the plate. In addition, it is not mandatory to design the stamp for embossing as well as for cutting out. Basically, it is also possible to design the stamp for embossing or for cutting out only.

The motif itself is freely selectable within wide limitations depending on the individual application and customer needs. Basically, all motifs are possible that can be represented graphically by the individual stamp size with the possible dimensions of projections and/or indentations.

It is also possible that at least one first projection and/or at least one indentation for embossing is arranged outside a second projection formed as a closed contour for cutting out on the base surface. This way, it would be possible to cut out one dough piece or the like and to emboss another dough piece or the like in one work process.

The use of a stamp according to the invention is not limited to dough. Rather, the stamp can also be used for embossing and/or cutting out of other suitable materials. For example, the stamp according to the invention can also be used for other activities such as printing.

In addition to the above explanations, it would also be possible that the handle in its neutral and/or usage position is fixed in a detachable manner via a corresponding catch of the handle and the plate.

The plate does not have to be flat but can also be curved. Here, the top and the base surface are curved and parallel to each other. For example, this would be reasonable in case of a stamp according to the invention that is intended as an addition to a curved package, a glass or the like. This way, the stamp could be fixed tightly to the package.

Also, the top surface and the base surface do not have to be parallel to each other. For example, it is possible that the plate has a flat top surface and a curved base surface, similar to a planoconvex design. In addition, the top and the base surface can be curved, similar to a biconvex design.

In case of the above-mentioned alternatives, the height of the plate, i.e. the distance between the top and the base surface, is not constant. As a result, the handle of a stamp according to the invention, according to claim 2, is formed and attached to the plate in such a way that the handle in its neutral position is not substantially higher than the height of the plate at any place of the stamp.

Besides plastics, other materials such as metals, metal alloys and composite materials are also possible. The technician will, depending on the individual application, select the appropriate materials for the plate and at least one handle. It is not necessary for the two materials to correspond.

For example, in addition to the first projections (8) and the second projections (10), further projections and/or indentations can be provided that form further levels when embossing and/or cutting out and that make for an especially appealing design for the embossed and/or cut-out product.

For example, the same height can be chosen for the projections (8, 10) and possible other projections in an alternative execution form of the stamp according to the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims

What is claimed is:

1. A stamp for embossing or cutting out, the stamp comprising:
a plate having at least one handle and having a top surface and a base surface opposite to the top surface as well as an edge surface connecting the top surface and the base surface;
at least one projection protruding from the base surface and/or at least one indentation protruding into the base surface; and
an articulated connection to attach the handle to the plate, the articulated connection being movable from a neutral to a usage position and vice versa.

2. The stamp according to claim 1, wherein the handle is formed and arranged on the plate such that the handle is not higher than the plate.

3. The stamp according to claim 1, wherein the handle and the plate are made from one piece.

4. The stamp according to claim 1, wherein the handle is formed as a bow handle and is attached to the plate by two spaced-out hinges.

5. The stamp according to claim 1, wherein the handle, in a neutral position, encloses the plate at least partially at the edge.

6. The stamp according to claim 5, wherein the handle encloses the plate such that a plate contour at an edge is substantially continuous with the handle.

7. The stamp according to claim 1, wherein the plate and/or the handle is/are made from plastic.

8. The stamp according to claim 1, wherein the stamp with the handle, in a neutral position, has a total height of less than or equal to 3.3 mm.

9. The stamp according to claim 1, wherein the projection has a height and/or the indentation has a depth of less than or equal to 1.8 mm.

10. The stamp according to claim 1, wherein the stamp has at least one projection and a second projection; the second projection being formed as a closed contour, peripheral to the first projection and/or the indentation and, in relation to the base surface, has a height that exceeds the height of the first projection.
